(19) United States
(12) Patent Application Publication
(10) Pub. No.: US 2014/0359741 A1
(43) Pub. Date: Dec. 4, 2014

(54) Mutually Authenticated Communication

(71) Applicant: Entersekt International Limited, Ebene (MU)

(72) Inventors: Christoph Albrecht Kistner, Stellenbosch (ZA); Gert Stephanus Herman Maritz, Somerset West (ZA)

(21) Appl. No.: 14/362,307

(22) PCT Filed: Nov. 30, 2012
(86) PCT No.: PCT/IB2012/056852

§ 371 Date: Jun. 2, 2014

(30) Foreign Application Priority Data
Dec. 2, 2011 (ZA) 2011/08870

(51) Int. Cl. H04L 29/06; H04W 12/06

(52) U.S. Cl. CPC H04L 63/0869; H04L 63/0823; H04W 12/06; H04L 63/0428
USPC 726/7

(57) ABSTRACT

A method and system for securing an electronic communications session between a mobile device and a network server is provided. The method includes requesting, from the mobile device, a unique session identifier from an authentication server. The authentication server in turn requesting the session identifier from the network server on behalf of the mobile device and, upon receipt thereof, communicating it to the mobile device over a secure communication channel between the mobile device and the authentication server, established using a unique digital certificate on the mobile device which was previously issued to it by a trusted certification authority. The session identifier being useable by the mobile device and network server to secure, mutually validate and authenticate the electronic communication session between them conducted by means of a conventional electronic communications protocol.

### FIELD OF THE INVENTION

This invention relates to a method of securing an electronic communication session between a mobile communications device and a remotely accessible network device.

### BACKGROUND TO THE INVENTION

Mobile communication devices, such as mobile phones, are becoming increasingly popular as a means for browsing the Internet and for conducting electronic commerce transactions. As most mobile phones were not originally designed for this purpose they pose a number of additional security risks that conventional computers do not. This has led to an increase in unscrupulous operations and security threats for users browsing the Internet and transacting from their mobile phones.

The most commonly used transfer protocol for providing encrypted communications between Internet enabled computers and network devices, such as servers, is currently Hypertext Transfer Protocol Secure (HTTPS). This protocol is used extensively by network operators that host websites or other services containing or dealing with data that is of a personal or sensitive nature. HTTPS is based on standard Hypertext Transfer Protocol (HTTP) commonly used for most Internet communications, but has an additional Transport Layer Security (TLS) protocol, or the older Secure Sockets Layer (SSL) protocol, that ensures encrypted communication and secure identification of network devices hosting the websites or services that a user is communicating with.

The main concept behind HTTPS is to create a secure channel over which electronic communications may be conducted over essentially insecure networks. HTTPS attempts to provide protection for both the network device hosting a service and users of that service from eavesdroppers and so-called “man-in-the-middle” attacks.

The trust inherent in HTTPS is based on digital certificates issued by certification authorities of which the root certificates come pre-installed with most conventional Internet browser software operating on computers. Most security protocols that are currently in use require the devices from which they are used to have a substantial amount of processing power. TLS (as well as Secure Sockets Layer or “SSL”, its predecessor) is what is known as a cryptographic protocol and is used to encrypt segments of network connections at the application layer to ensure secure end-to-end transit at the transport layer. For mutual (also referred to as bilateral) implementations, SSL is, however, problematic for mobile devices for a variety of reasons, one of which is the fact that handsets generally do not have the processing power to calculate their own private and public cryptographic key pairs that can be used for secure communication. Apart from it potentially being impossible for mobile devices to request certificates in some cases, the process will in other cases still be complex and tedious. In addition, most mobile devices simply do not have enough Root Certificates pre-installed on them to enable them to accept any normal sub-set of certificates issued by conventional Certification Authorities (CAs).

As a result of the above limitations it is often problematic for a web server (or other network device) to verify that the mobile phone (or other mobile communications device) with which it is communicating over a mutual HTTPS network session is who it purports to be. Most network device operators are accordingly loath to transmit sensitive information over network sessions with mobile phones or other mobile communications devices. This inhibits the use of technology as users still have to have access to computers in order to use the full host of services offered by most online application servers, especially servers requiring a mutually validated SSL/TLS connection.

International patent application number PCT/IB2011/002305 in the name of Entersect International Limited, discloses a system and method for authenticating a communications channel between a mobile device and an application server, for uniquely identifying the mobile device and for encrypting communications between the mobile device and the application server over the communication channel. The application also discloses the issuing of digital certificates to mobile communication devices as well as application servers, which may, amongst others, be used by the communications devices and application servers to uniquely identify one another.

PCT/IB2011/002305 is incorporated into this specification in its entirety by reference.

Despite the additional security provided by systems such as those disclosed in PCT/IB2011/002305, most mobile phone Internet browsers and other mobile phone applications still prefer and attempt to establish independent connections with network devices, such as web servers, when initiated. These independent connections are typically established by means of standard protocols such as HTTPS, with verification in most cases limited to the server's certificate. As soon as this is done, it again becomes problematic for the remote network device to verify the identity of the mobile device with which it is communicating.

There is accordingly a need to provide additional security for electronic communication sessions between mobile communications devices and other network devices conducted over standard communications protocols such as, for example, HTTPS.

In the remainder of this specification the term “mobile device” should be interpreted to include any mobile communications device capable of communicating over a communications network, such as a cellular network, and having at least a limited amount of processing power. The term should be interpreted to specifically include all mobile or cellular phones but may also include portable computers such as laptops, handheld personal computers and the like.

In addition, the term “network server” should be interpreted to include any network device capable of accepting a communications payload over an electronic communications network.

### SUMMARY OF THE INVENTION

In accordance with this invention there is provided a method of securing an electronic communication session between a mobile device and a network server, the mobile device being uniquely associated with a user and the method being carried out at an authentication network server and comprising the steps of:
receiving a request for a unique session identifier from the mobile device wishing to connect securely to the network server, the mobile device being identified by the authentication network server by means of a unique digital certificate which was issued to it by a trusted certification authority;
requesting a session identifier from an issuing server, the request including a unique device identifier for the mobile device;
receiving a unique session identifier for the requesting mobile device from the issuing server;
establishing a secure, encrypted connection with the mobile device using the digital certificate; and
transmitting the unique session identifier to the mobile device over the secure, encrypted connection, the session identifier being useable by the mobile device and network server to secure and mutually validate and authenticate an electronic communication session conducted by means of a conventional electronic communications protocol.

Further features of the invention provide for the method to include the steps of receiving the request for a session identifier from a software application installed and operating on the mobile device; enrolling the user with the authentication network server if it was not previously so enrolled; issuing the mobile device with a unique digital certificate during the enrolment; uniquely associating an identity of a user of the mobile device with the digital certificate; and transmitting the identity of the user together with or in the place of the device identifier to the authentication network server with the request for a session identifier.

Still further features of the invention provide for the certification authority to be the authentication network server; for the issuing server to be the network server; and for the conventional electronic communications protocol to be a conventional Internet communications protocol such as HTTPS.

The invention also provides a system for securing and mutually validating and authenticating an electronic communications session between a mobile device of a user and a network server, the system including a remotely accessible authentication network server configured to:
enrol a user for a service and uniquely associate a digital certificate stored on the mobile device with a user record of the user;
receive a request for a session identifier from the mobile device of an enrolled user;
request a session identifier from the network server, the request including a unique device identifier of the requesting mobile device;
receive a unique session identifier generated by the network server;
establish a secure, encrypted connection with the mobile device using the unique digital certificate; and
transmit the unique session identifier to the mobile device over the secure encrypted connection,
   the network server in turn being configured to:
receive the request for a session identifier from the authentication network server;
generate the unique session identifier;
store the unique session identifier, together with the unique device identifier in a database; and
conduct an electronic communications session with a mobile device by means of a conventional electronic communications protocol if communications from the mobile device includes a session identifier which can be matched to a unique session identifier stored in the database.

Further features of the invention provide for the network server to be further configured to associate a user record with the unique device identifier; to receive an electronic communications access request from the mobile device; to extract a unique session identifier from the electronic communications access request and look up the extracted unique session identifier in the database; to allow the mobile device access to electronic communications if the unique session identifier contained in the electronic communications access request matches a unique session identifier stored in the database; and to determine the identity of the user associated with the mobile device by inspecting the user record associated with the unique device identifier in the database.

Still further features of the invention provide for the mobile device to include a software application associated with the authentication network server installed and operating on it; for the mobile device to transmit the request for the session identifier to the authentication network server by means of the software application; and for the software application to be configured to initiate an electronic communication session with the network server either directly or by means of another software application operating on the mobile device upon receipt of the unique session identifier from the authentication network server, and to include the unique session identifier in an electronic communications access request transmitted to the network server with which the mobile device wishes to communicate securely.

### BRIEF DESCRIPTION OF THE DRAWINGS

In the drawings:

FIG. 1 is a schematic illustration of a system for securing an electronic communication session between a mobile device and a network server in accordance with the invention; and

FIG. 2 is a flow diagram illustrating the operation of the system described with reference to FIG. 1.

### DETAILED DESCRIPTION WITH REFERENCE TO THE DRAWINGS

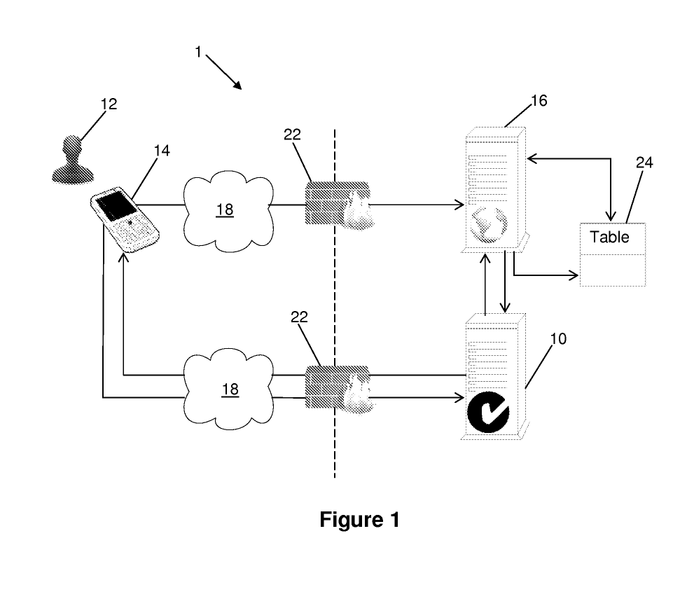

A system (1) for securing an electronic communications session, in the current example an Internet browsing session, between a mobile device (14), in this example a mobile phone, of a user (12) and a network server (16), in this example a web server, is shown in FIG. 1. The web server (16) is operated by an entity and enables its customers to interact with it over an electronic communications network (18), in this example the Internet, and transact with the entity. For this purpose, the web server (16) hosts an Internet website (not shown) which provides an interface for performing the transactions.

The system (1) includes an authentication network server (10), which is typically installed and operating at the entity's premises. The entity enables users (12) to register for services offered by it. To register for the services, a user (12), amongst other possible steps, is required to enrol with the authentication network server (10). This enrolment procedure is conducted from the user's mobile device (14), which has a software application associated with the authentication network server (10) installed and operating on it. During the enrolment procedure, the entity links the user's (12) identity to a unique identifier associated with a digital certificate generated by a trusted certification authority (CA) (not shown), and which is stored on the mobile device (14). The user's identity and the unique identifier are then stored in a database (24) (or other suitable storage means) in a user record associated with the user (12). The unique identifier may simply be a sequential number allocated to the digital certificate at the time of its creation.

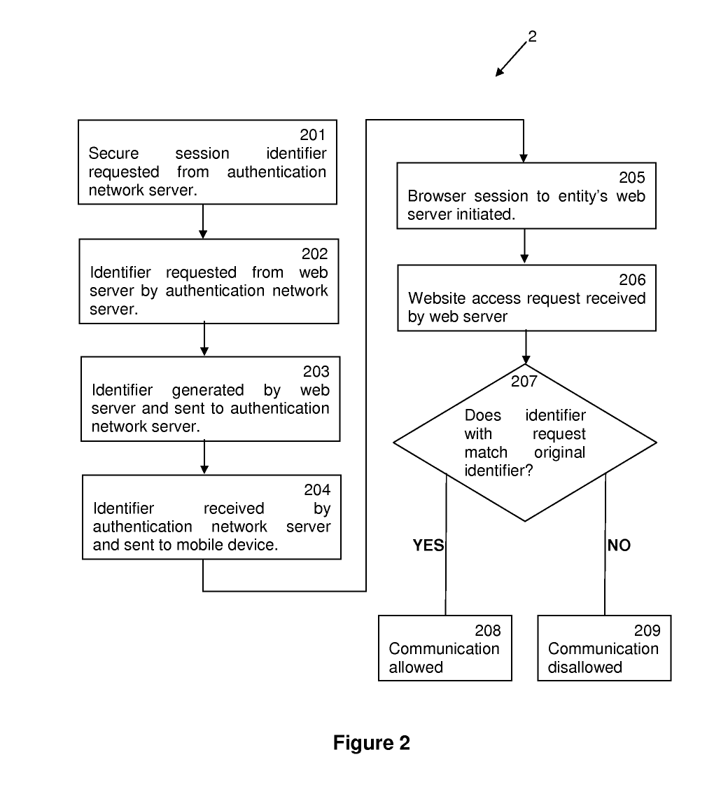

When a user (12) wants to open a secure Internet browser session from his or her mobile device (14) to the network server, or the entity's website for that matter, he or she initiates the software application installed on the mobile device (14). Once the application is initiated, it establishes a secure connection between the mobile device (14) and the authentication network server (10) hosted on the entity's premises, behind the entity's firewall (22). The secure connection is established by utilising the unique digital certificate previously issued by the trusted CA (not shown) and stored on the mobile device (14) to mutually validate the communicating entities and encrypt all data between the device (14) and the authentication network server (10). The user (12) then selects an option listed by the software application to browse to the entity's website, which initiates the following sequence of events which is illustrated in more detail in the flow diagram (2) shown in FIG. 2:

1. In an initial step (201), the software application on the mobile device (14) requests a unique secure session identifier from the authentication network server (10) over the encrypted connection between the mobile device (14) and the authentication network server (10).

2. In a next step (202), the authentication network server (10), in turn, requests a unique secure session identifier from the web server (16) on behalf of the requesting mobile device (14). Along with the request, the authentication network server (10) transmits the unique identifier associated with the device's digital certificate to the web server (16).

3. In a further step (203), the web server (16) then generates a unique secure session identifier for the requesting device (14) and stores the device's unique identifier associated with its digital certificate, together with the generated unique secure session identifier in the database (24). In addition, it also sends the unique secure session identifier back to the authentication network server (10).

4. Upon receipt of the unique secure session identifier in a still further step (204), the authentication network server (10) sends the unique secure session identifier back to the application on the mobile device (14), over the secure connection.

5. In a next step (205) the application on the mobile device (14) initiates a secure Internet browser session to the entity's web server (16) by means of a secure HTTPS protocol and transmits the unique secure session identifier with its communication in the packet headers of the website access request.

6. Upon receipt of the website access request, the web server (16) extracts the unique session identifier from the communication and checks the database (24) to verify if the unique secure session identifier is valid and also with which user identity it is associated in a further step (206).

7. At step (207) the web server (16) looks up the unique session identifier in the database (24). If the session identifier is stored in the database (24) and is associated with a valid user identity corresponding to a registered mobile device (14), communication between the web server (16) and the mobile device browser by means of the secure protocol is allowed to continue at step (208).

8. If, however, it is determined by the web server (16) at step (207) that the unique session identifier is not stored in the database (24), or that it is not associated with a valid user identity corresponding to a registered mobile device (14), communication between the web server (16) and the mobile device browser by means of the secure protocol is disallowed at step (209).

It should be appreciated that since the unique secure session identifier could only have been acquired by the mobile device (14) over the secure, encrypted channel by an authenticated user, and the communication to the web server (16) is done over an HTTPS secured connection, the browser session is secure and the web server (16) knows exactly who the authenticated user (12) browsing the website is by mapping the unique secure session identifier to the device identifier and mapping the device identifier to the user record linked to it.

It will further be apparent that the method and system of the invention may be used to secure any electronic communications session between a mobile device and a network server and that it is not limited to Internet web browsing sessions as described in the above example. The fact that the unique secure session identifier is communicated to the mobile device over an encrypted channel which could only have been established from an authenticated, enrolled device, makes it possible for the network server to verify the identity of the mobile device and user with which it is communicated.

The above description is by way of example only and it should be appreciated that numerous changes and modifications may be made to the embodiment of the invention described without departing from the scope of the invention. The architectural layout of the system may, for example, be changed in a number of ways. The authentication network server may, for example, not be implemented and operating on the entity's premises, but may be operated by an independent third party authentication service provider, in which case communication between the authentication service provider and network server may also be conducted over an encrypted communications channel over a network. Likewise, the authentication network server may also be hosted in the cloud.

While the communication between the authentication network server and the web server in the example described is conducted over a local or wide area network it should be apparent that such communications may likewise be conducted over any network, including the Internet. In addition, it is foreseen that the secure connection between the authentication network server and the mobile device may only be established once the authentication network server has received the session identifier from the web server. The important consideration is that the session identifier will only be transmitted to the mobile device after the secure connection encrypted by means of the digital identifier has been established.

In an alternative embodiment of the invention it may be possible for the authentication network server to create the unique session identifier itself, in which case it may be transmitted by the authentication network server to both the network server and the mobile device.

It should also be appreciated that, while referred to in the above description as a “network server”, the system and method of the invention may be used to secure a communication session between a mobile device and any other networked communications device which is configured to allow interaction with, and provide services to, users from mobile devices.

1. A method of securing an electronic communication session between a mobile device and a network server, the mobile device being uniquely associated with a user and the method being carried out at an authentication server and comprising the steps of:
receiving a request for a unique session identifier from the mobile device wishing to establish the communication session with the network server, the mobile device being identified by the authentication server by means of a unique digital certificate which was issued to it by a trusted certification authority;
requesting a session identifier from an issuing server, the request including a unique device identifier for the mobile device;
receiving a unique session identifier for the requesting mobile device from the issuing server;
establishing a secure, encrypted connection with the mobile device using the digital certificate; and
transmitting the unique session identifier to the mobile device over the secure, encrypted connection, the session identifier being useable by the mobile device and network server to secure, mutually validate and authenticate the electronic communication session conducted by means of a conventional electronic communications protocol.

2. The method as claimed in claim 1 further including the steps of receiving the request for a session identifier from a software application installed and operating on the mobile device, enrolling the user with the authentication server if it was not previously so enrolled, issuing the mobile device with a unique digital certificate during the enrolment, uniquely associating an identity of a user of the mobile device with the digital certificate, and transmitting the identity of the user together or in the place of the device identifier to the authentication network server with the request for a session identifier.

3. The method as claimed in claim 1, wherein the trusted certification authority is the authentication server.

4. The method as claimed in claim 1, wherein the issuing server is the network server.

5. The method as claimed in claim 1, wherein the conventional electronic communications protocol is a conventional Internet communications protocol.

6. The method as claimed in claim 5, wherein the conventional Internet communications protocol is HTTPS.

7. A system for securing and mutually validating and authenticating an electronic communications session between a mobile device of a user and a network server, the system including a remotely accessible authentication server configured to:
enrol a user for a service and uniquely associate a digital certificate stored on the mobile device with a user record of the user;
receive a request for a session identifier from the mobile device of an enrolled user;
request a session identifier from the network server, the request including a unique device identifier of the requesting mobile device;
receive a unique session identifier generated by the network server;
establish a secure, encrypted connection with the mobile device using the unique digital certificate; and
transmit the unique session identifier to the mobile device over the secure encrypted connection,
the network server in turn being configured to:
receive the request for a session identifier from the authentication server;
generate the unique session identifier;
store the unique session identifier, together with the unique device identifier in a database; and
conduct an electronic communications session with a mobile device by means of a conventional electronic communications protocol if communications from the mobile device includes a session identifier which can be matched to a unique session identifier stored in the database.

8. The system as claimed in claim 7, wherein the network server is further configured to associate a user record with the unique device identifier; to receive an electronic communications access request from the mobile device; to extract a unique session identifier from the electronic communications access request and look up the extracted unique session identifier in the database; to allow the mobile device access to electronic communications if the unique session identifier contained in the electronic communications access request matches a unique session identifier stored in the database; and to determine the identity of the user associated with the mobile device by inspecting the user record associated with the unique device identifier in the database.

9. The system claimed in claim 7, wherein the mobile device includes a software application associated with the authentication server installed and operating on it.

10. The system as claimed in claim 9, wherein the mobile device transmits the request for the session identifier to the authentication server by means of the software application.

11. A system as claimed in claim 9, wherein the software application is configured to initiate an electronic communication session with the network server either directly or by means of another software application operating on the mobile device upon receipt of the unique session identifier from the authentication server, and to include the unique session identifier in an electronic communications access request transmitted to the network server with which the mobile device wishes to communicate securely
